(19) United States
(12) Patent Application Publication
(10) Pub. No.: US 2008/0270155 A1
(43) Pub. Date: Oct. 30, 2008

(54) Central integrated method and system for digital signage and customer call-forward

(75) Inventor: Eran Reuveni, Tel Aviv (IL)

Correspondence Address: KATTEN MUCHIN ROSENMAN LLP, 575 MADISON AVENUE, NEW YORK, NY, 10022-2585, US

(73) Assignee: Q-nomy, Inc.

(21) Appl. No.: 11/789,934

(22) Filed: Apr. 26, 2007

(51) Int. Cl. G06Q 10/00; G08B 21/22

(52) U.S. Cl. 705/1; 340/540; 340/666; 715/716

(57) ABSTRACT

A method for a service process by at least one agent for the benefit of a plurality of customers forming a line, the process performed by a central integrated system for digital signage and customer call-forward from a line in a service area. The method includes entering by one of the plurality of customers into the service area and joining by the one of the plurality of customers in the line. The method also includes calling by the at least one agent of the one of the plurality of customers and indicating by the system of the availability of the at least one agent. Next, the one of the plurality of customers approaches the at least one agent, the at least one agent provides service to the one of the plurality of customers and the one of the plurality of customers exits the service area, wherein the digital signage and customer call-forward process are integrated and seamless for the plurality of customers.

### FIELD OF THE INVENTION

The present invention relates generally to customer call centers, and more particularly, the invention relates to a central integrated method and system for digital signage and customer call-forward.

### BACKGROUND OF THE INVENTION

In the environment of service areas, customers may queue up by standing in line without taking numbers, e.g. in a bank or a pharmacy. In this environment, the current state of the art would be one of the following:

customers move forward with the line, and approach an available agent from the front of the line, when they see the agent becomes available; an

agents use a dedicated, locally installed system for calling the next customer forward when they are available (usually using buttons activating electronic displays and/or a chime).

Occasionally, in this environment there would also be a digital signage system for display ads, information and other media (henceforth referred to as “Content”) on wall-mounted screens. The digital signage system would be separate from the ‘call-forward’ system, and use different displays.

Thus it would be advantageous to have a method which integrates digital signage and call-forward into a single application, utilizing the same screens to display contents and call-forward messages.

### SUMMARY OF THE INVENTION

Accordingly, it is a principal object of the present invention to provide a method for a centralized system, which integrates digital signage and call-forward into a single application, utilizing the same screens to display contents and call-forward messages.

It is another principal object of the present invention to increase the visibility and impact of content by displaying it where customers need to look.

It is one other principal object of the present invention to save hardware costs by doubling the usage of each screen.

A method is disclosed for a service process by at least one agent for the benefit of a plurality of customers forming a line, the process performed by a central integrated system for digital signage and customer call-forward from a line in a service area. The method includes entering by one of the plurality of customers into the service area and joining by the one of the plurality of customers in the line. The method also includes calling by the at least one agent of the one of the plurality of customers and indicating by the system of the availability of the at least one agent. Next, the one of the plurality of customers approaches the at least one agent, the at least one agent provides service to the one of the plurality of customers and the one of the plurality of customers exits the service area, wherein the digital signage and customer call-forward process are integrated and seamless for the plurality of customers.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in which:

FIG. 1 is a block diagram of the components of the linestream system, constructed according to the principles of the present invention;

FIG. 2 illustrates the customer service process when using the system, performed according to the principles of the present invention; and

FIG. 3 illustrates an exemplary combination of content and call-forward messages on the Screen.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

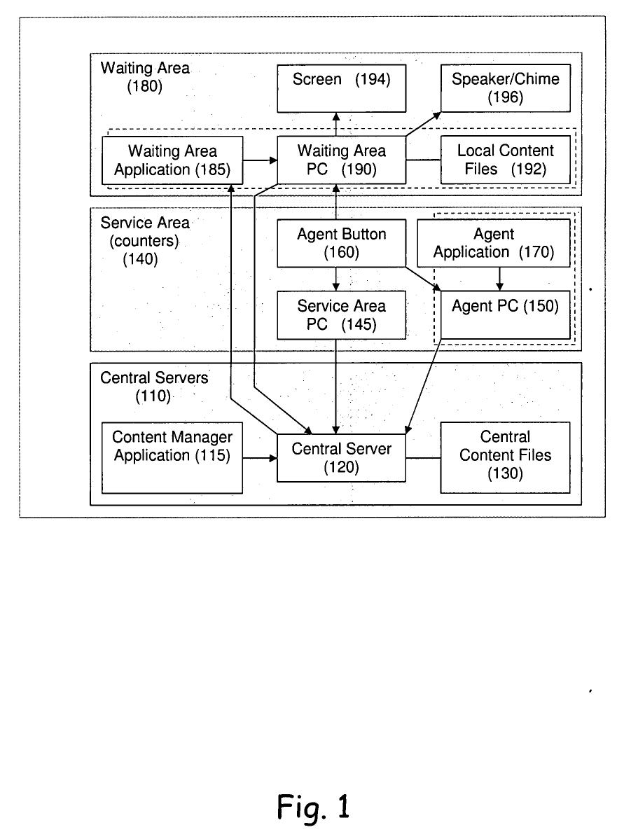

FIG. 1 is a block diagram of the components of the linestream system, constructed according to the principles of the present invention. The system includes the following components:

In the area of the Central Servers 115 there is: a Content Manager Application 115, which controls waiting area displayed contents by editing play-lists and saving them onto a Central Server 120; a Central Server 120, which receives ‘call forward’ commands from Service Area PC 145, Agent PC 150 or Waiting Area PC 190, and sends messages to corresponding Waiting Area Application 185 telling it what to play: Content Play-List and/or Call Forward message; and a Central Content Files 130 are easy to manage and can be played by Waiting Area Application as an alternative to Local Content Files 192.

In the Service Area 140 there are counters for: the Service Area PC 145, which can be used to handle Agent Button 160 input as an alternative to Agent PC 150, e.g. if agents do not use PC's and which relays such input up to the Central Server 120; the Agent PC 150 can be used to run Agent Application 170 or to get input from Agent Button 160 as an alternative to using Service Area PC; and the Agent Button 160 is a simple electric device used by agents to call the next customer, and comprises a circuit closed by a normally-open/push-to-close button, relayed to the Service Area PC 145, or Waiting Area PC 190 via COM, USB or any other available port (various electronic variations can be implemented).

The Agent Application 170 is a simple software application used by agents to call the next customer, running on Agent PC 150, comprising an on-screen button. Agent Application 170 is an alternative to Agent Button 160.

In the Waiting Area 180 are found: the Waiting Area Application 185, which is a software application that receives input from the Central Server 120 and manages equipment connected to the Waiting Area PC. It controls content played on the Screen 194, occasional Call Forward messages played on Screen 194, and/or Call Forward voice or sound played on Speaker/Chime 196; the Waiting Area PC 190 controls Screen 194 and Speaker/Chime 196, and might receive input from Agent Button 160 and it runs Waiting Area Application 185 and may also contain the Local Content Files 192; Local Content Files 192, which do not consume runtime bandwidth and can be played by Waiting Area Application as an alternative to Central Content Files 130.

Screen 194 is controlled by Waiting Area PC 190 and is used to display contents and call-forward messages. The Speaker/Chime 196 is controlled by Waiting Area PC 190 and used to play call-forward voice or sound. Note that Central Server 120 may serve multiple service areas (each with multiple agents) and multiple waiting areas (each with multiple screens and speakers/chimes).

A few optional complementary or replacement elements may be implemented with the system, so as to adapt it to specific local, high-end or future requirements. These elements do not constitute a different concept, but a slightly different implementation of the same main concept:

Replacement Devices for Agent Application 170 and Button 160: In specific scenarios, agents may want or need to call customers forward using other available devices (e.g. Telephone, Palm or Pocket PC, Thin Client Workstation, Wireless Device etc.) that would interface with the Central Server 120 directly or through the network, through an Agent PC 150 or Service Area PC 145, or through any other computer, gateway or link;

Replacement Sensors for Agent Application 170 and Button 160: In specific scenarios, sensors may detect agent is available (infra-red across agent's side of counter or weight sensor in agent's chair) or that a customer has left (infra-red across customer's side of counter or weight sensor in customer's chair), to call the next customers;

Add-on that lights up a counter-display: Counter Displays may be installed at the counter, which would light up (with the counter number or any other design) when the agent calls a customer forward. Counter Displays may be lit by input from the Central Server 120, Agent PC 150, Service Area PC 145 or Waiting Area PC 190. Displays may be Computer screens, LED Matrix or Seven Segment displays or simple lights;

Add-on that monitors and records agent activity: the Central Server 120 may include the capacity to record agent's activity (calling customers forward), and enable analysis of agent productivity and total service-center throughput;

Add-on for content play-list management: the Central Server 120 may include a user interface for features such as: allowing easy and/or sophisticated editing of content play-lists, distributing content files from Central Server to Waiting Area PCs 190, monitoring Screen 194 status etc. and any other feature normally attributed to Digital Signage management;

Inclusion in more extensive Customer Flow Management system: Central Server 120 may be a part, a component, a sub-service or a feature of a more extensive customer flow management system. For instance, the Customer Flow Management system may be enhanced to serve a process in line with the described Process; and

Server sharing/hosting: Central Server 120 may be hosted outside the organization and may be used to serve multiple organizations.

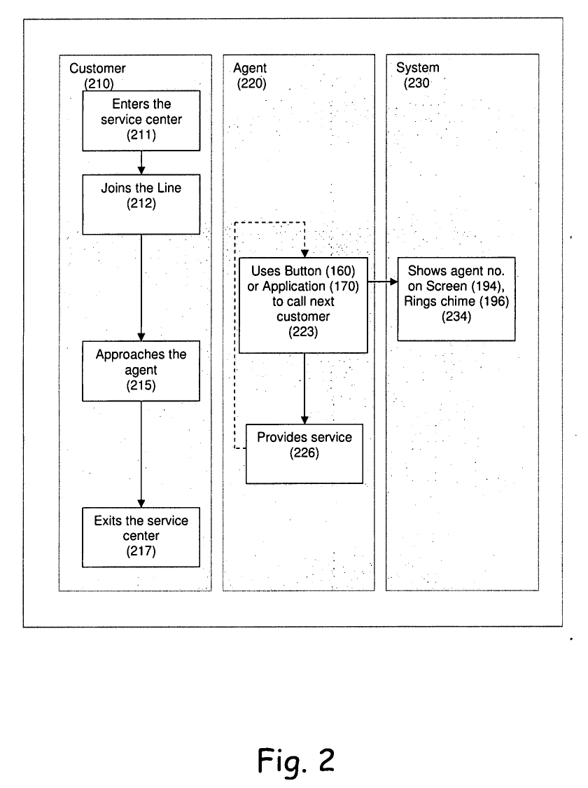

FIG. 2 illustrates the customer service process when using the system, performed according to the principles of the present invention. The customer service process begins for a customer 210 when he enters the service area 211 and joins the line 212. Next, when the turn of customer 210 arrives, customer 210 is called 223 by an agent 220 using a button 160 or an application 170. The number of agent 220 is shown on screen 194 and chime 196 rings 234. Subsequently, customer 210 approaches 215 agent 220 and agent 220 provides service 226. Finally, customer 210 exits 217 service area 211.

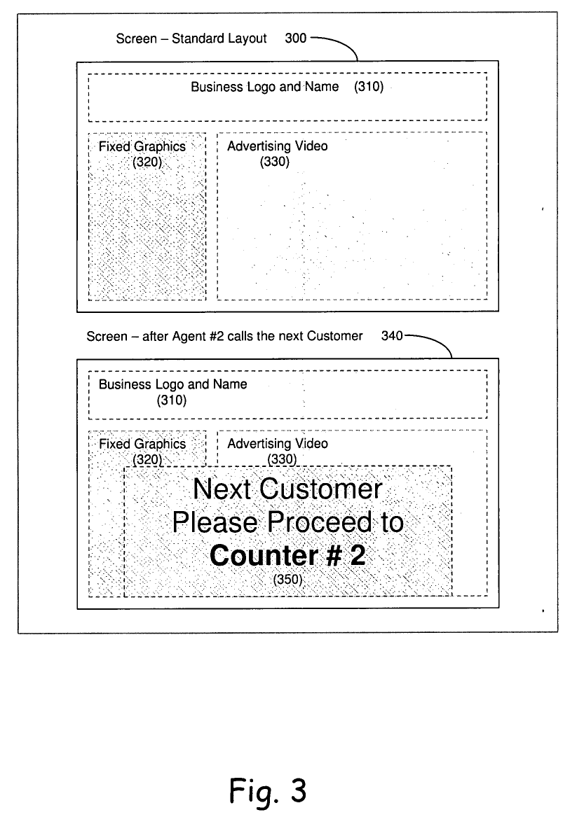

FIG. 3 illustrates an exemplary combination of content and call-forward messages on the screen, according to the principles of the present invention. A “between calls” layout 300 shows the business logo and name 310, fixed graphics 320 and an advertising video 330. After agent #2 calls the next customer 340, the screen also displays: “Next Customer Please Proceed to Counter #2” 350.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method for a service process by at least one agent for the benefit of a plurality of customers forming a line in a service area, the process performed by a central integrated system for digital signage and customer call-forward, said method comprising:
entering by one of the plurality of customers into the service area;
joining by said one of the plurality of customers in the line;
calling by the at least one agent of said one of the plurality of customers;
indicating by the system of the availability of the at least one agent;
approaching of the at least one agent by said one of the plurality of customers;
providing service by the at least one agent to said one of the plurality of customers; and
exiting the service area by said one of the plurality of customers,
wherein the digital signage and customer call-forward process are integrated and seamless for the plurality of customers.

2. The method of claim 1, wherein said calling step is by means of a push button.

3. The method of claim 1, wherein said calling step is by means of an application.

4. The method of claim 1, wherein said indicating step comprises at least one of showing the number of the at least one agent on a screen in the service area and ringing a chime in the service area.

5. A system for a service process by at least one agent for the benefit of a plurality of customers forming a line in a service area of an organization, the process performed by a central integrated system for digital signage and customer call-forward, said system comprising:
a Content Manager Application, which controls displayed contents by editing play-lists and saving them onto the Central Server;
a Central Server, which receives ‘call forward’ commands from one of:
a Service Area PC;
an Agent PC; and
a Waiting Area PC,
wherein said Central Server sends messages to a corresponding Waiting Area Application telling it what to play;
one of an Agent Application and an Agent Button used by said at least one agent to call the next of the plurality of customers;
a Waiting Area Application, which receives input from said Central Server and manages equipment connected to the Waiting Area PC;
a Waiting Area PC, which:
controls a Screen and at least one of one of a Speaker and Chimes; and
runs said Waiting Area Application,
wherein said Screen is controlled by said Waiting Area PC and is used to display contents and call-forward messages, and wherein said at least one of Speaker and Chimes is controlled by said Waiting Area PC and used to play call-forward voice or sound.

6. The system of claim 5, wherein said Service Area PC, said Waiting Area PC and said Agent PC are one and the same.

7. The system of claim 5, wherein said Agent Button is a simple electric device used by said at least one agent to call the next of said plurality of customers, and comprises a circuit closed by a normally-open/push-to-close button, relayed to one of said Service Area PC and said Waiting Area PC via one of COM, USB and any available port.

8. The system of claim 5, wherein said Agent Application comprises an on-screen button.

9. The system of claim 5, wherein said Waiting Area Application controls content and occasional Call Forward messages played on said screen and one of Call Forward voice and sound played on said one of Speaker and Chimes.

10. The system of claim 5, wherein said Waiting Area PC receives input from said Agent Button.

11. The system of claim 5, wherein said Waiting Area PC contains the Local Content Files 192; which can be played by said Waiting Area Application.

12. The system of claim 5, further comprising Replacement Devices for said Agent Application and said Agent Button.

13. The system of claim 5, wherein said at least one agent calls one of said plurality of customers forward using at least one the following available devices: Telephone, Palm, Pocket PC, Thin Client Workstation, and a Wireless Device, wherein said at least one available devices interfaces with said Central Server in one of the following ways: directly, through a network, through said Agent PC, through said Service Area PC, through another computer, through a gateway and through a link.

14. The system of claim 5, further comprising Replacement Sensors for said Agent Application and said Agent Button 160.

15. The system of claim 14, wherein said sensors detect said at least one agent is available.

16. The system of claim 15, wherein said detection is by means of infra-red across said at least one agent's side of counter.

17. The system of claim 15, wherein said detection is by means of a weight sensor in said at least one agent's chair.

18. The system of claim 14, wherein said sensors detect that one of said plurality of customers has left.

19. The system of claim 18, wherein said detection is by means of infra-red across one of said plurality of customer's side of counter for signaling a call the next of said plurality of customers.

20. The system of claim 18, wherein said detection is by means of a weight sensor in across one of said plurality of customer's chair for signaling a call the next of said plurality of customers.

21. The system of claim 5, further comprising an Add-on that lights up at least one Counter Display:

22. The system of claim 21, wherein said at least one Counter Display is installed at the counter and lights up with the counter number when said at least one agent calls one of said plurality of customers forward.

23. The system of claim 21, wherein said at least one Counter Display is lit by input from one of said Central Server, said Agent PC, said Service Area PC and said Waiting Area PC.

24. The system of claim 21, wherein said at least one Counter Display comprise one of Computer screens, LED Matrix, Seven Segment displays and simple lights.

25. The system of claim 5, further comprising an Add-on that monitors and records activity of said at least one agent.

26. The system of claim 5, wherein said Central Server includes the capacity to record the activity of said at least one agent and enables analysis of agent productivity and total service-center throughput.

27. The system of claim 5, further comprising an Add-on for content play-list management.

28. The system of claim 5, wherein said Central Server includes a user interface for features such as: allowing easy and sophisticated editing of content play-lists, distributing content files from said Central Server to said Waiting Area PC's and monitoring said Screen status.

29. The system of claim 5, wherein said Central Server is hosted outside the organization and is used to serve multiple organizations.
